(19) United States
(12) Patent Application Publication
(10) Pub. No.: US 2025/0351107 A1
(43) Pub. Date: Nov. 13, 2025

(54) SYSTEMS AND METHODS FOR A STATIC IP ADDRESS SERVICE

(71) Applicant: Verizon Patent and Licensing Inc., Basking Ridge, NJ (US)

(72) Inventors: Nitul Mehta, Nashua, NH (US); Raymond Wai-Man So, San Ramon, CA (US); Emerando M. Delos Reyes, Pleasant Hill, CA (US); Jerry Steben, Fort Worth, TX (US)

(21) Appl. No.: 18/658,256

(22) Filed: May 8, 2024

(51) Int. Cl. H04W 60/04; H04L 61/5007; H04W 8/26; H04W 12/06

(52) U.S. Cl. CPC H04W 60/04; H04L 61/5007; H04W 8/26; H04W 12/06

(57) ABSTRACT

A system may include a device configured to receive a registration request from a Session Management Function (SMF) associated with an Internet Protocol (IP) address range or an IP index and store information associating the SMF with the IP address range or the IP index. The device may be further configured to receive, from a network function (NF), a query for a particular SMF associated with the IP address or the IP index; identify the SMF associated with the IP address or the IP index as the particular SMF; and provide, to the NF, information identifying the SMF based on the received query.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to access and use various services via the provider's communication network across different types of devices or access points. Managing a wireless communication service over time across different devices or access points may pose various difficulties.

### BRIEF DESCRIPTION OF THE DRAWINGS

FIG. 1 illustrates an environment according to an implementation described herein;

FIG. 2 illustrates exemplary components of a core network according to an implementation described herein;

FIG. 3 illustrates exemplary components of a device that may be included in a component of an environment according to an implementation described herein;

FIG. 4 illustrates exemplary components of an Access and Mobility Function (AMF) device according to an implementation described herein;

FIG. 5 illustrates exemplary components of a Network Repository Function (NRF) device according to an implementation described herein;

FIG. 6 illustrates exemplary components of an Unified Data Management (UDM) device according to an implementation described herein;

FIG. 7 illustrates exemplary components of Session Management Function (SMF) device according to an implementation described herein;

FIG. 8 illustrates a flowchart of a process for determining an SMF associated with an Internet Protocol (IP) address or IP index according to an implementation described herein;

FIG. 9 illustrates a flowchart of a process for providing information identifying an SMF associated with an Internet Protocol (IP) address or IP index according to an implementation described herein;

FIG. 10 illustrates a flowchart of a process for authorizing a static IP service according to an implementation described herein;

FIG. 11 illustrates a flowchart of a process for providing a static IP service according to an implementation described herein;

FIG. 12 illustrates a first exemplary signal flow diagram according to an implementation described herein; and

FIG. 13 illustrates a second exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable wireless communication devices (e.g., smart phones, etc.), referred to as user equipment (UE) devices (also herein referred to as UEs), to connect to networks and obtain services via the provider's core network, such as a Fourth Generation (4G) core network, a Fifth Generation (5G) core network, and/or other next generation networks as defined by the 3^{rd} Generation Partnership Project (3GPP). 5G coverage may be provided using 5G base stations, referred to as gNodeBs, implementing the 5G New Radio (NR) air interface.

In order to establish a communication session, a UE device may establish a Protocol Data Unit (PDU) session in the core network via a RAN. The PDU session may be used by the UE device to connect to an Internet Protocol (IP) network, also referred to as a Packet Data Network (PDN). For example, a UE device may connect to an application server in the PDN via a gateway device in the core network. In a 5G core network, a Session Management Function (SMF) may establish the PDU session to the PDN. During the PDU session establishment process, the SMF may select a User Plane Function (UPF) to function as a gateway for the data traffic between the UE device and the PDN. The SMF may assign an IP address to the UE device from a pool of IP addresses available to the SMF and the UE device may use the IP address when communicating with the PDN. In some implementations, the IP address may be assigned to the UE device by the UPF.

A core network may include multiple (and potentially a large number of) SMFs. When a PDU session ends, the IP address assigned to the UE device may be released back to the pool of IP addresses that may be allocated to the SMF for assignment to UE devices. If the UE device later attempts to reconnect to the PDN, the UE device may be assigned to an available SMF that is different from the previous SMF assigned to the UE device. Thus, the UE device may be assigned an IP address that is different from the previous IP address that was assigned to the UE device. Therefore, IP address assignment may be dynamic and the UE device may be associated with a different IP address for a subsequent PDU session.

However, in some situations it may be desirable to maintain a static IP address for a UE device. For example, an enterprise may maintain a large number of UE devices (e.g., for employees, customers, etc.) and a PDN, and may require or prefer to maintain the same IP addresses for UE devices accessing the PDN. As an example, if static IP addresses for UE devices are maintained, an application server may be able to identify UE devices based on IP addresses associated with the UE devices. Maintaining a static IP address for a UE device may not be possible if a different SMF is assigned to the UE device from a previously assigned SMF.

Implementations described herein relate to systems and methods for a static IP address service. A static IP address service may be made available by a provider of wireless communication services and a UE device subscription may include the static IP address service. The static IP address service may guarantee, or give best effort, that an IP address assigned to the UE device will remain the same each time the UE device connects to a PDN.

A Unified Data Management (UDM) device in a core network may be configured to store, in a subscription record associated with the UE device, an indication that the UE device is authorized for the static IP address service. The UDM device may be further configured to receive a request from an SMF for authorization for the static IP address service for the UE device and provide the authorization for the static IP address service for the UE device to the requesting SMF based on the stored indication and the received request.

A network repository function (NRF) device in the core network may be configured to maintain information relating SMFs in the core network and IP addresses associated with particular SMFs. For example, the NRF may receive a registration from an SMF associated with a range of IP addresses or an IP index and store information associating the SMF with the range of IP addresses or an IP index. An IP index may correspond to an identifier associated with an SMF for the purpose of selecting the SMF for a UE device in order to assign the same IP address that was previously assigned to the UE device.

When an SMF assigns an IP address to a UE device associated with a static IP address service, the SMF may instruct the UE device to store an IP address index or may set a flag in a message to the UE device instructing the UE device to store the IP address assigned to the UE device. In response, when the UE device sends a subsequent PDU establishment request to the core network, the UE device may provide the stored IP address or the IP index in the PDU session establishment request in order to enable the core network to select an SMF associated with the IP address previously assigned to the UE device.

An Access and Mobility Management Function (AMF) device in the core network may be configured to receive, from the UE device, the PDU session establishment request with the included IP address or IP index, and send, in response, a query to the NRF for an SMF associated with the IP address or IP index. The NRF device may be further configured to receive the query, identify the SMF associated with the IP address or the IP index and provide, based on the received query, information identifying the SMF to the AMF device. The AMF device may be further configured to receive the information identifying the SMF from the NRF, and send the PDU session establishment request to the identified SMF, in response to receiving the information identifying the SMF.

An SMF device may be configured to register with the NRF with information identifying the IP index or a range of IP addresses used by the SMF for assigning to UE devices when establishing PDU sessions. The SMF device may be further configured to receive a PDU session establishment request for the UE device from the AMF, send a request for an authorization for a static IP address service for the UE device to the UDM, and receive the authorization for the static IP address service for the UE device from the UDM.

In response to the received authorization, the SMF device may identify an IP address previously assigned to the UE device by the SMF, assign the identified IP address to the UE device for the PDU session, and instruct the UE device to store the IP address and/or the IP index and use the stored IP address and/or IP index in future requests for PDU sessions. The SMF may complete the PDU session establishment for the UE device and manage the PDU session.

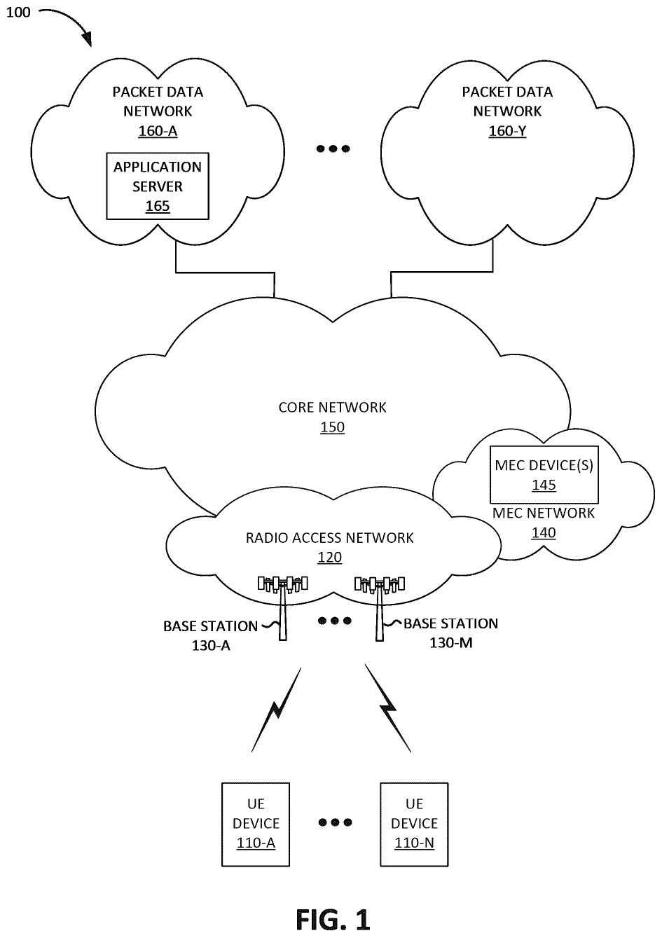

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a RAN 120 that includes base stations 130-A to 130-M (referred to herein collectively as “base stations 130” and individually as “base station 130”), a Multi-Access Edge Computing (MEC) network 140, a core network 150, and packet data networks (PDNs) 160-A to 160-Y (referred to herein collectively as “PDNs 160” and individually as “PDN 160”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a WI-FI access point (AP); a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

RAN 120 may include base stations 130 and be managed by a provider of wireless communication services. RAN 120 may enable UE devices 110 to connect to core network 150 via base stations 130 using cellular wireless signals. For example, RAN 120 may include one or more central units (CUs), distributed units (DUs), and/or Radio Units (RUs) (not shown in FIG. 1) that enable and manage connections from RUs to core network 150. RAN 120 may include features associated with an LTE Advanced (LTE-A) network and/or a 5G network or other advanced network, such as management of 5G NR base stations; carrier aggregation; advanced or massive MIMO configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Base station 130 may include a 5G NR base station (e.g., a gNodeB) and/or a 4G Long Term Evolution (LTE) base station (e.g., an eNodeB). Base stations 130 may include devices and/or components configured to enable cellular wireless communication with UE devices 110. For example, base stations 130 may include a radio frequency (RF) transceiver configured to communicate with UE devices 110 using a 5G NR air interface using a 5G NR protocol stack, a 4G LTE air interface using a 4G LTE protocol stack, and/or using another type of cellular air interface.

MEC network 140 may be associated with RAN 120 and may provide MEC services for UE devices 110 attached to base stations 130. MEC network 140 may be in proximity to base stations 130 from a geographic and network topology perspective, thus enabling low latency services to be provided to UE devices 110. As an example, MEC network 140 may be located on the same site as base station 130. As another example, MEC network 140 may be geographically closer to one of base stations 130 and reachable via fewer network hops and/or fewer switches, than other macro cell base stations 130.

MEC network 140 may include one or more MEC devices 145. MEC devices 145 may provide MEC services to UE devices 110. A MEC service may include, for example, a low-latency microservice associated with a particular application, a microservice associated with a virtualized network function (VNF) of core network 150, a cloud computing service, such as cache storage service, artificial intelligence (AI) accelerator service, machine learning service, an image processing service, a data compression service, a locally centralized gaming service, a Graphics Processing Units (GPUs) and/or other types of hardware accelerator service, and/or other types of cloud computing services.

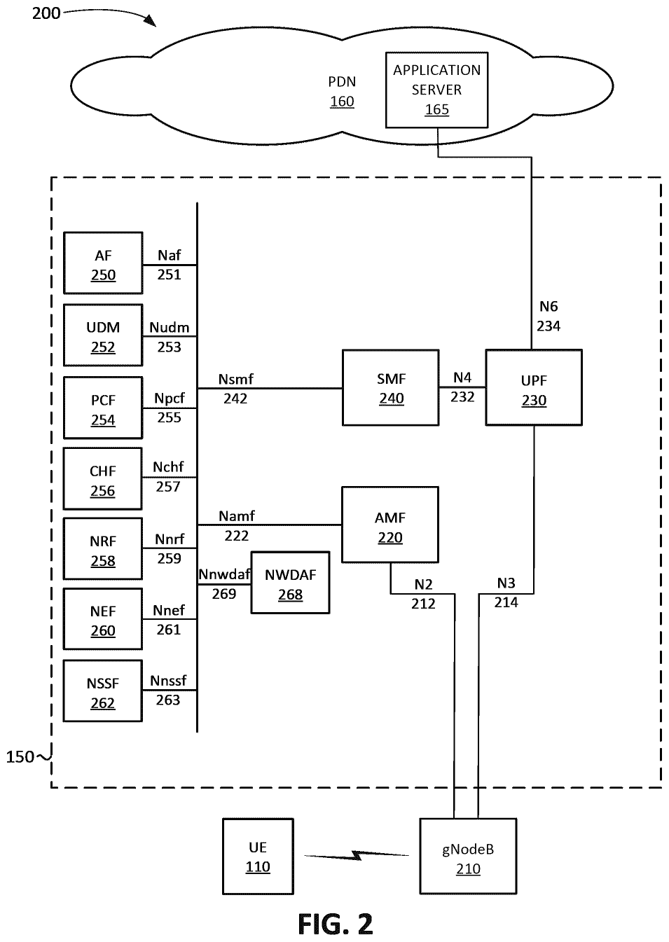

Core network 150 may be managed by the provider of cellular wireless communication services and may manage communication sessions of subscribers connecting to core network 150 via RAN 120. For example, core network 150 may establish an Internet Protocol (IP) connection between UE devices 110 and PDN 160. In some implementations, core network 150 may include a 5G core network. Exemplary components that may be included in core network 150 are described below with reference to FIG. 2.

PDNs 160-A to 160-Y may each be associated with a Data Network Name (DNN) in 5G, and/or an Access Point Name (APN) in 4G. UE device 110 may request a connection to PDN 160 using a DNN or an APN. For example, UE device 110 may request a data flow connection to an application server 165 (shown in PDN 160-A). PDN 160 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 165. Application server 165 may include one or more computer devices that host one or more applications and/or other types of services used by UE device 110. Core network 150 may establish a data flow session between UE device 110 and application server 155 via RAN 120.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

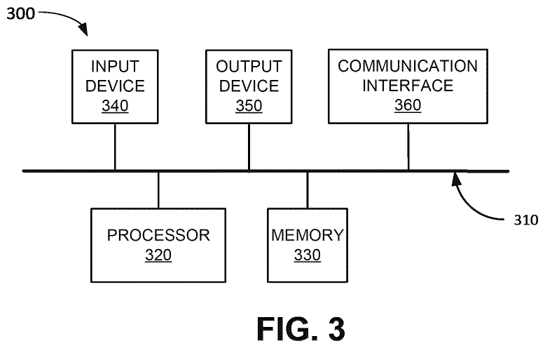

FIG. 2 illustrates an implementation 200 of core network 150 as a 5G core network. As shown in FIG. 2, implementation 200 includes UE device 110, gNodeB 210, core network 150, and PDN 160. gNodeB 210 may be implemented by base station 130. The components of core network 150 may be implemented as dedicated hardware components and/or as Virtual Network Functions (VNFs) implemented on top of a common shared physical infrastructure using Software Defined Networking (SDN). For example, an SDN controller may implement one or more of the components of core network 150 using an adapter implementing a VNF virtual machine, a Cloud-Native Network Function (CNF) container, an event driven serverless architecture, and/or another type of SDN architecture. The common shared physical infrastructure may be implemented using one or more devices 300 described below with reference to FIG. 3 in a cloud computing center associated with core network 150. Additionally, or alternatively, at least some of the components of core network 150 may be implemented using MEC devices 145 in MEC network 140.

Core network 150 may include an AMF 220, a UPF 230, an SMF 240, an Application Function (AF) 250, a UDM 252, a Policy Charging Function (PCF) 254, a Charging Function (CHF) 256, an NRF 258, a Network Exposure Function (NEF) 260, a Network Slice Selection Function (NSSF) 262, and a Network Data Analytics Function (NWDAF) 268. While FIG. 2 depicts a single AMF 220, UPF 230, SMF 240, AF 250, UDM 252, PCF 254, CHF 256, NRF 258, NEF 260, NSSF 262, and NWDAF 268 for illustration purposes, in practice, core network 150 may include multiple AMFs 220, UPFs 230, SMFs 240, AFs 250, UDMs 252, PCFs 254, CHFs 256, NRFs 258, NEFs 260, NSSFs 262, and/or NWDAFs 268.

AMF 220 may perform registration management, connection management, reachability management, mobility management, lawful intercepts, session management messages transport between UE device 110 and SMF 240, access authentication and authorization, location services management, support non-3GPP access networks, and/or other types of management processes. AMF 220 may be accessible by other function nodes via an Namf interface 222. AMF 220 may communicate with gNodeB 210 via an N2 interface 212. AMF 220 may obtain information identifying a particular SMF 240, associated with a IP address or an IP index, from NRF 258.

UPF 230 may maintain an anchor point for intra/inter-Radio Access Technology (RAT) mobility, maintain an external PDU point of interconnect to a particular PDN 160, perform packet routing and forwarding, perform the user plane part of policy rule enforcement, perform packet inspection, perform lawful intercept, perform traffic usage reporting, perform Quality of Service (QOS) handling in the user plane, perform uplink traffic verification, perform transport level packet marking, perform downlink packet buffering, forward an “end marker” to a RAN node (e.g., gNodeB 210), and/or perform other types of user plane processes. UPF 230 may communicate with gNodeB 210 using an N3 interface 214, communicate with SMF 240 using an N4 interface 232, and connect to PDN 160 using an N6 interface 234. In some implementations, some or all of the functionality described herein, relating to implementing a static IP address service by SMF 240, may be performed by UPF 230.

SMF 240 may perform session establishment, session modification, and/or session release, apply policies received from PCF 254 to data flows, perform IP address allocation and management, perform Dynamic Host Configuration Protocol (DHCP) functions, perform selection and control of UPF 230, configure traffic steering at UPF 230 to guide the traffic to the correct destinations, perform lawful intercepts, charge data collection, support charging interfaces, control and coordinate charging data collection, terminate session management parts of Non-Access Stratum messages, perform downlink data notification, manage roaming functionality, and/or perform other types of control plane processes for managing user plane data. SMF 240 may be accessible via an Nsmf interface 242.

SMF 240 may implement a static IP address service for UE device 110. For example, SMF 240 may register with NRF 258 and provide information, identifying a range of IP addresses or an IP index associated with SMF 240, to NRF 258 so that NRF 258 may identify SMF 240 when a PDU session establishment request, associated with the range of IP addresses or the IP index, is received by core network 150. Furthermore, SMF 240 may assign an IP address to UE device 110 for a PDU session, instruct UE device 110 to store an IP index or to store the IP address assigned to UE device 110, and assign the same IP address to UE device 110 for subsequent PDU sessions.

AF 250 may provide services associated with a particular application, such as, for example, an application for influencing traffic routing, an application for accessing NEF 260, an application for interacting with a policy framework for policy control, and/or other types of applications. AF 250 may be accessible via an Naf interface 251, also referred to as an NG5 interface. In some implementations, AF 250 may correspond to, or interface with, application server 165. In some applications, AF 250 may process a request from application server to add a static IP address service to a subscription associated with UE device 110 by sending an instruction to UDM 252 to add the static IP address service to the subscription associated with UE device 110.

UDM 252 may maintain subscription information for UE devices 110, manage subscriptions, generate authentication credentials, handle user identification, perform access authorization based on subscription data, maintain service and/or session continuity by maintaining assignment of SMF 240 for ongoing sessions, support lawful intercept functionality, and/or perform other processes associated with managing user data. UDM 252 may interface with a Unified Data Repository (UDR) that stores, in a subscription profile associated with a particular UE device 110, a list of network slices which the particular UE device 110 is allowed to access. UDM 252 may be accessible via a Nudm interface 253. UDM 252 may store an indication as to whether UE device 110 is authorized for a static IP address service and may respond to requests to authorize the static IP address service from SMF 240.

PCF 254 may support policies to control network behavior, provide policy rules to control plane functions (e.g., to SMF 240) and/or access and mobility functions (e.g., to AMF 220), provide a UE device Route Selection Policy (URSP) to UE device 110, access subscription information relevant to policy decisions, perform policy decisions, and/or perform other types of processes associated with policy enforcement. PCF 254 may be accessible via Npcf interface 255. CHF 256 may perform charging and/or billing functions for core network 140. For example, CHF 256 may receive information relating to a data session from SMF 240, generate a charging record for the data session based on the received information, and provide the generated charging record to a billing system. CHF 256 may be accessible via Nchf interface 257.

NRF 258 may support a service discovery function and maintain profiles of available network function (NF) instances and their supported services. An NF profile may include an NF ID, an NF type, a Public Land Mobile Network (PLMN) ID associated with the NF, network slice IDs associated with the NF, capacity information for the NF, service authorization information for the NF, supported services associated with the NF, endpoint information for each supported service associated with the NF, and/or other types of NF information. NRF 258 may be accessible via an Nnrf interface 259. NRF 258 may store, for each particular SMF 240, information identifying a range of IP addresses or an IP index associated with the particular SMF 240.

NEF 260 may expose services, capabilities, and/or events to other NFs, including third party NFs, AFs 250, edge computing NFs, and/or other types of NFs. Furthermore, NEF 260 may secure provisioning of information from external applications to core network 150, translate information between core network 150 and devices/networks external to core network 150, support a Packet Flow Description (PFD) function, and/or perform other types of network exposure functions. NEF 260 may be accessible via an Nnef interface 261.

NSSF 262 may select a set of network slice instances to serve a particular UE device 110, determine network slice selection assistance information (NSSAI), determine a particular AMF 220 to serve a particular UE device 110, and/or perform other types of processing associated with network slice selection or management. NSSF 262 may provide a list of allowed slices for a particular UE device 110 to UDM 252 to store in a subscription profile associated with the particular UE device 110. NSSF 262 may be accessible via Nnssf interface 263. NWDAF 268 may collect analytics information associated with RAN 120 and/or core network 150. For example, NWDAF 268 may collect and/or obtain Key Performance Indicators (KPIs) information relating to UE device 110 in RAN 130 and/or core network 150. NWDAF 268 may be accessible via Nnwdaf interface 269.

Although FIG. 2 shows exemplary components of core network 150, in other implementations, core network 150 may include fewer components, different components, differently arranged components, or additional components than depicted in FIG. 2. Additionally, or alternatively, one or more components of core network 150 may perform functions described as being performed by one or more other components of core network 150. Furthermore, while particular interfaces have been described with respect to particular function nodes in FIG. 2, additionally, or alternatively, core network 150 may include a reference point architecture that includes point-to-point interfaces between particular function nodes.

FIG. 3 is a diagram illustrating example components of a device 300 according to an implementation described herein. The components of FIG. 1 and/or FIG. 2 may each include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some implementations, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the user. In some implementations, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a WiFi) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations relating to a static IP address service in a core network associated with a RAN. Device 300 may perform these operations in response to processor 320 executing software instructions contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

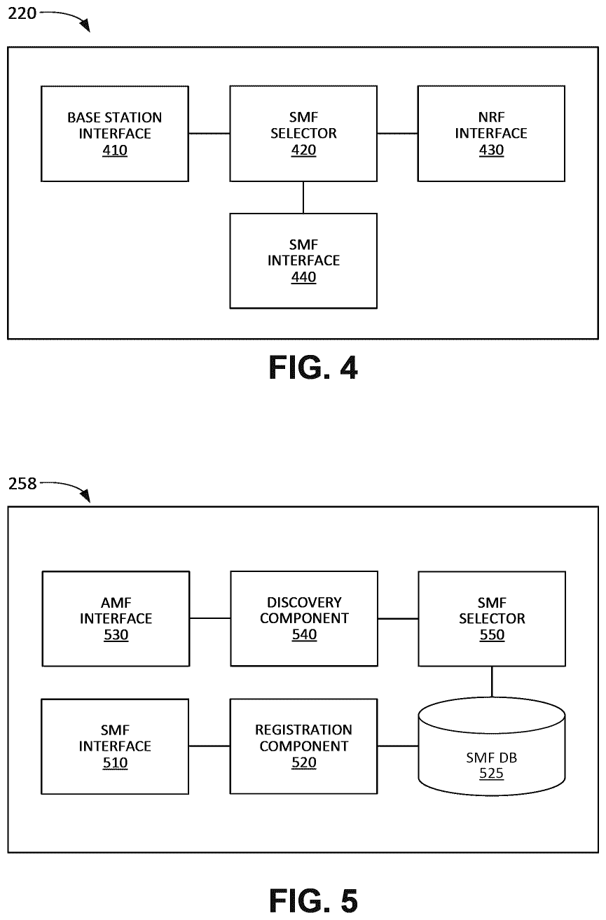

FIG. 4 illustrates exemplary components of AMF 220. The components of AMF 220 may be implemented, for example, via processor 320 executing instructions from memory 330. For example, one or more components of AMF 220 may correspond to the structure of processor 320 together with instructions in memory 330 for implementing the functionality of the component. Alternatively, some or all of the components of AMF 220 may be implemented via hard-wired circuitry. For example, one or more components of AMF 220 may correspond to the structure of some or all of an ASIC, FPGA, and/or another type of integrated circuit. As shown in FIG. 4, AMF 220 may include a base station interface 410, an SMF selector 420, an NRF interface 430, and an SMF interface 440.

Base station interface 410 may be configured to communicate with base station 130. For example, base station interface 410 may be configured to implement and/or use N2 interface 212. Base station interface 410 may receive a request from UE device 110 via base station 130 to establish a PDU session. The PDU session establishment request may include an IP address or an IP index provided by UE device 110.

SMF selector 420 may select an SMF 240 for the PDU session request received from UE device 110. In some implementations, SMF selector 420 may first request authorization from UDM 252 to determine whether UE device 110 is authorized for a static IP address service before selecting SMF 240. SMF selector 420 may send a query to NRF 258 via NRF interface 430 to identify SMF 240 associated with the IP address or the IP index includes in the PDU session establishment request received from UE device 110. NRF interface 430 may be configured to communicate with NRF 258. For example, NRF interface 430 may be configured to implement and/or use Nnrf interface 259. NRF interface 430 may receive information identifying a particular SMF 240 associated with the IP address or the IP index from NRF 258 and provide the information to SMF selector 420. SMF selector may select the identified SMF 240 for the PDU session and may send the PDU session establishment request to the selected SMF 240 via SMF interface 440. SMF interface 440 may be configured to communicate with SMF 240. For example, SMF interface 440 may be configured to implement and/or use Nsmf interface 242.

Although FIG. 4 shows exemplary components of AMF 220, in other implementations, AMF 220 may include fewer components, different components, additional components, or differently arranged components than depicted in FIG. 4. Additionally, or alternatively, one or more components of AMF 220 may perform one or more tasks described as being performed by one or more other components of AMF 220.

FIG. 5 illustrates exemplary components of NRF 258. The components of NRF 258 may be implemented, for example, via processor 320 executing instructions from memory 330. For example, one or more components of NRF 258 may correspond to the structure of processor 320 together with instructions in memory 330 for implementing the functionality of the component. Alternatively, some or all of the components of NRF 258 may be implemented via hard-wired circuitry. For example, one or more components of NRF 258 may correspond to the structure of some or all of an ASIC, FPGA, and/or another type of integrated circuit. As shown in FIG. 5, NRF 258 may include an SMF interface 510, a registration component 520, an SMF database (DB) 525, an AMF interface 530, a discovery component 540, and an SMF selector 550.

SMF interface 510 may be configured to communicate with SMF 240. For example, SMF interface 510 may be configured to implement and/or use Nsmf interface 242. SMF interface 610 may receive an NF registration request from SMF 240. The NF registration request may include information identifying SMF 240 and information identifying a pool/range of IP addresses from which SMF 240 assigns IP addresses to UE devices 110 and/or an IP index associated with SMF 240. Registration component 520 may store the received information relating to SMF 240 in SMF DB 525. SMF DB 525 may store information relating to SMFs 240 in core network 150. For example, for each particular SMF 240, SMF DB 525 may store an identifier associated with the particular SMF 240, and address or reachability information for the particular SMF 240, a status associated with the particular SMF 240 (e.g., whether the particular SMF 240 is available, etc.), an IP index associated with the particular SMF 240, a pool/range of IP addresses from which SMF 240 assigns IP addresses to UE devices 110, and/or other types of information associated with the particular SMF 240.

AMF interface 530 may be configured to communicate with AMF 220. For example, AMF interface 530 may be configured to implement and/or use Namf interface 222. AMF interface 530 may receive a request from AMF 220 for information identifying a particular SMF 240 associated with an IP address or IP index. Discovery component 540 may receive the request from AMF interface 530 and perform a discovery process to identify the particular SMF 240 associated with the IP address or the IP index using SMF selector 550. Thus, discovery component 540 may “supernet” the IP address or the IP index to a range of IP addresses assigned to a particular SMF 240. SMF selector 550 may select the particular SMF 240 associated with the IP address or the IP index by accessing SMF DB 525. Discovery component 540 may provide information identifying the particular SMF 240 to AMF 220 via AMF interface 530.

Although FIG. 5 shows exemplary components of NRF 258, in other implementations, NRF 258 may include fewer components, different components, additional components, or differently arranged components than depicted in FIG. 5. Additionally, or alternatively, one or more components of NRF 258 may perform one or more tasks described as being performed by one or more other components of NRF 258.

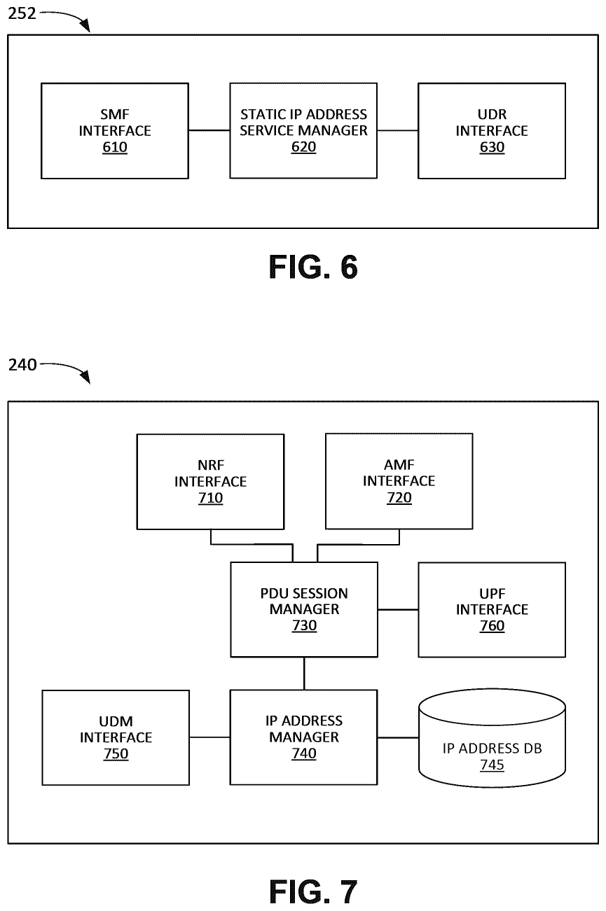

FIG. 6 illustrates exemplary components of UDM 252. The components of UDM 252 may be implemented, for example, via processor 320 executing instructions from memory 330. For example, one or more components of UDM 252 may correspond to the structure of processor 320 together with instructions in memory 330 for implementing the functionality of the component. Alternatively, some or all of the components of UDM 252 may be implemented via hard-wired circuitry. For example, one or more components of UDM 252 may correspond to the structure of some or all of an ASIC, FPGA, and/or another type of integrated circuit. As shown in FIG. 6, UDM 252 may include an SMF interface 610, a static IP address service manager 620, and a UDR interface 630.

SMF interface 610 may be configured to communicate with SMF 240. For example, SMF interface 610 may be configured to implement and/or use Nsmf interface 242. SMF interface 610 may receive a request from SMF 240 to authorize a static IP address service for UE device 110. Static IP address service manager 620 may determine whether to authorize a static IP address service for UE device 110. Static IP address service manager 620 may access a UDR via UDR interface 630 to determine whether a subscription for UE device 110 includes a static IP address service. UDR interface 630 may communicate with a UDR that stores subscription information for UE devices 110. If the subscription for UE device 110 includes the static IP address service, static IP address service manager 620 may generate the authorization and send the authorization to SMF 240 using SMF interface 610.

Although FIG. 6 shows exemplary components of UDM 252, in other implementations, UDM 252 may include fewer components, different components, additional components, or differently arranged components than depicted in FIG. 6. Additionally, or alternatively, one or more components of UDM 252 may perform one or more tasks described as being performed by one or more other components of UDM 252.

FIG. 7 illustrates exemplary components of SMF 240. The components of SMF 240 may be implemented, for example, via processor 320 executing instructions from memory 330. For example, one or more components of SMF 240 may correspond to the structure of processor 320 together with instructions in memory 330 for implementing the functionality of the component. Alternatively, some or all of the components of SMF 240 may be implemented via hard-wired circuitry. For example, one or more components of SMF 240 may correspond to the structure of some or all of an ASIC, FPGA, and/or another type of integrated circuit. As shown in FIG. 7, SMF 240 may include an NRF interface 710, an AMF interface 720, a PDU session manager 730, an IP address manager 740, an IP address DB 745, and a UDM interface 750.

NRF interface 710 may be configured to communicate with NRF 258. For example, NRF interface 710 may be configured to implement and/or use Nnrf interface 259. NRF interface 710 may be used by PDU session manager 730 to register SMF 240 with NRF 258 by sending an NF registration request to NRF 258. The registration request may include information identifying SMF 240 and information identifying a pool/range of IP addresses from which SMF 240 assigns IP addresses to UE devices 110 and/or an IP index associated with SMF 240.

AMF interface 720 may be configured to communicate with AMF 220. For example, AMF interface 720 may be configured to implement and/or use Namf interface 222. AMF interface 720 may receive a PDU session establishment request from AMF 220. The PDU session establishment request may include information identifying UE device 110, such as, for example, a Mobile Directory Number (MDN), an International Mobile Subscriber Identity (IMSI), a Mobile Station International Subscriber Directory Number (MSISDN), an International Mobile Equipment Identity (IMEI), an ID associated with the subscription for UE device 110 (e.g., a subscription ID, an account number, etc.), and/or another type of ID for the particular UE device 110.

PDU session manager 730 may manage PDU sessions. For example, PDU session manager 730 may set up a PDU session between UE device 110 and PDN 160 based on a received PDU session establishment request. PDU session manager 730 may select a particular UPF 230 and instruct the selected UPF 230 to set up a PDU session between UE device 110 and PDN 160 using UPF interface 760. During PDU session establishment, PDU session manager 730 may use IP address manager 740 to assign an IP address to UE device 110. UPF interface 760 may be configured to communicate with UPF 230. For example, UPF interface 70 may be configured to implement and/or use N4 interface 232.

IP address manager 740 may assign an IP address to UE device 110 for a PDU session from a pool/range of IP addresses. IP address DB 745 may store information identifying the pool/range of IP addresses used by SMF 240 to assign an IP address to UE device 110 for a PDU session. For each IP address, IP address DB 745 may identify whether the IP address is available or assigned to a particular UE device 110. If the IP address is available, IP address DB 745 may store information identifying a UE device 110 to which the IP address has been previously assigned. Additionally, or alternatively, IP address DB 745 may store an IP index associated with SMF 240. The IP index may correspond to an identifier associated with SMF 240 for the purpose of selecting SMF 240 for UE device 110 by NRF 258 in order to assign a same IP address to UE device 110 as the previously assigned IP address. Furthermore, IP address DB 745 may store, for each particular UE device 110 for which SMF 240 is managing a PDU session or for which SMF 240 has previously managed a PDU session, an IP address assigned or previously assigned to the particular UE device 110 and information indicating whether the particular UE device 110 is authorized for a static IP address service. IP address manager 740 may assign a previously assigned IP address to UE device 110 for a PDU session if UE device 110 is authorized for the static IP address service.

Furthermore, if UE device 110 is authorized for the static IP address service, PDU session manager 730 may instruct UE device 110, via AMF 220 using AMF interface 720, to store the assigned IP address by setting a flag in a Non-Access Stratus (NAS) message or by providing an IP index to UE device 110 in the NAS message. UE device 110 may store the IP address or the IP index and include the IP address or IP index in subsequent PDU session establishment requests to core network 150.

UDM interface 750 may be configured to communicate with UDM 252. For example, UDM interface 750 may be configured to implement and/or use Nudm interface 253. IP address manager 740 may use UDM interface 750 to send a request to UDM 252 to authorize IP address static service for UE device 110. If UE device 110 is authorized for the IP address static service UDM interface 750 may receive the authorization and provide the authorization to IP address manager 740.

Although FIG. 7 shows exemplary components of SMF 240, in other implementations, SMF 240 may include fewer components, different components, additional components, or differently arranged components than depicted in FIG. 7. Additionally, or alternatively, one or more components of SMF 240 may perform one or more tasks described as being performed by one or more other components of SMF 240.

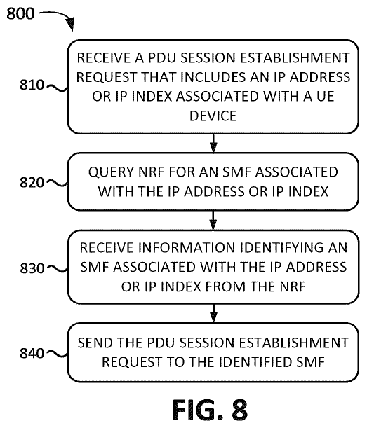

FIG. 8 illustrates a flowchart of a process 800 for determining an SMF associated with an IP address or IP index. In some implementations, process 800 of FIG. 8 may be performed by AMF 220. In other implementations, some or all of process 800 may be performed by another device or a group of devices separate from AMF 220.

As shown in FIG. 8, process 800 may include receiving a PDU session establishment request that includes an IP address or an IP index associated with a UE device (block 810). For example, AMF 220 may receive a request from UE device 110 via base station 130 to establish a PDU session. The PDU session establishment request may include an IP address or an IP index provided by UE device 110.

Process 800 may further include querying an NRF for an SMF associated with the IP address or IP index (block 820), receiving information identifying the SMF associated with the IP address or IP index from the NRF (block 830), and sending the PDU session establishment request to the identified SMF (block 840). For example, AMF 220 may send a query to NRF 258 to identify SMF 240 associated with the IP address or the IP index includes in the PDU session establishment request received from UE device 110. In some implementations, AMF 220 may first request authorization from UDM 252 to determine whether UE device 110 is authorized for a static IP address service before selecting SMF 240. AMF 220 may receive information identifying a particular SMF 240 associated with the IP address or the IP index from NRF 258, select the identified SMF 240 for the PDU session, and send the PDU session establishment request to the selected SMF 240.

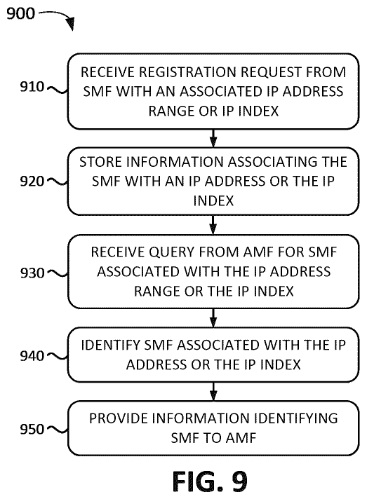

FIG. 9 illustrates a flowchart of a process 900 for providing information identifying an SMF associated with an IP address or IP index. In some implementations, process 900 of FIG. 9 may be performed by NRF 258. In other implementations, some or all of process 900 may be performed by another device or a group of devices separate from NRF 258.

As shown in FIG. 9, process 900 may include receiving a registration request from an SMF with an associated IP address range or an IP index (block 910) and storing the information associating the SMF with the IP address range or the IP index (block 920). For example, NRF 258 may receive an NF registration request from SMF 240. The NF registration request may include information identifying SMF 240 and information identifying a pool/range of IP addresses from which SMF 240 assigns IP addresses to UE devices 110 and/or an IP index associated with SMF 240. NRF 258 may store the received information relating to SMF 240 in SMF DB 525.

Process 900 may further include receiving a query from an AMF for an SMF associated with an IP address or an IP index (block 930), identifying the stored SMF associated with the IP address or the IP index (block 940), and providing the information identifying the SMF to the AMF (block 950). For example, NRF 258 may receive a request from AMF 220 for information identifying a particular SMF 240 associated with an IP address or IP index. NRF 258 may identify the particular SMF 240 associated with the IP address or the IP index, and provide information identifying the particular SMF 240 to AMF 220.

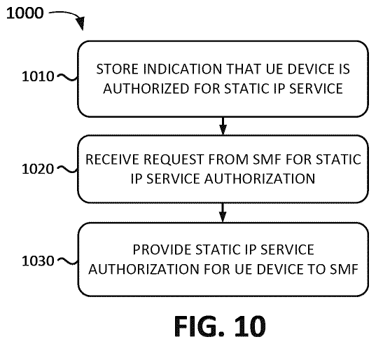

FIG. 10 illustrates a flowchart of a process 1000 for authorizing a static IP service. In some implementations, process 1000 of FIG. 10 may be performed by UDM 252. In other implementations, some or all of process 1000 may be performed by another device or a group of devices separate from UDM 252.

As shown in FIG. 10, process 1000 may include storing an indication that a UE device is authorized for a static IP address service (block 1010), receiving a request from an SMF for a static IP address service authorization (block 1020), and providing the static IP address authorization to the SMF (block 1030). For example, UDM 252 may store an indication that UE device 110 is authorized for a static IP address service in a UDR. UDM 252 may receive a request from SMF 240 to authorize a static IP address service for UE device 110, determine whether to authorize the static IP address service for UE device 110 by determining whether a subscription for UE device 110 includes a static IP address service, and, if the subscription for UE device 110 includes the static IP address service, send the authorization to SMF 240.

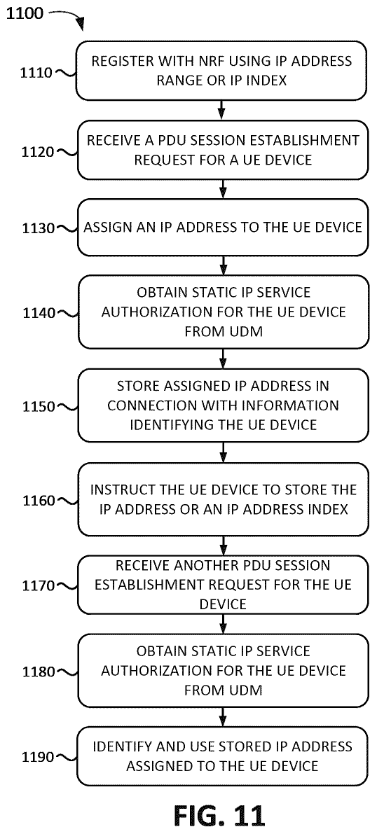

FIG. 11 illustrates a flowchart of a process 1100 for providing a static IP service. In some implementations, process 11100 of FIG. 11 may be performed by SMF 240. In other implementations, some or all of process 1100 may be performed by another device or a group of devices separate from SMF 240.

As shown in FIG. 11, process 1100 may include registering with an NRF using an IP address range or an IP index (block 1110). For example, SMF 240 may send an NF registration request to NRF 258. The NF registration request may include information identifying SMF 240 and information identifying a pool/range of IP addresses from which SMF 240 assigns IP addresses to UE devices 110, and/or an IP index associated with SMF 240.

Process 1100 may further include receiving a PDU session establishment request for a UE device (block 1120) and assigning an IP address to the UE device (block 1130). For example, SMF 240 may receive a PDU session establishment request for UE device 110 from AMF 220. The PDU session establishment request may include information identifying UE device 110, such as, for example, an MDN, an IMS), an MSISDN, an IMEI, an ID associated with the subscription for UE device 110, and/or another type of ID for the particular UE device 110.

Process 1100 may further include obtaining a static IP service authorization for the UE device from the UDM (block 1140), storing the assigned IP address in connection with the information identifying the UE device (block 1150), and instructing the UE device to store the IP address or the IP address index (block 1160). For example, SMF 240 may send a request to UDM 252 to authorize IP address static service for UE device 110 and receive the authorization from UDM 252. SMF 240 may store information relating to the authorization for UE device 110 in IP address DB 745. Furthermore, SMF 240 may instruct UE device 110, via AMF 220, to store the assigned IP address by setting a flag in a NAS message or by providing an IP index to UE device 110 in the NAS message. SMF 240 may then establish the PDU session for UE device 110 using the selected IP address. After the PDU session ends, SMF 240 may release the resources associated with the PDU session, but may reserve the assigned IP address for future use by UE device 110. In other words, SMF 240 may remove the assigned IP address from the pool of available IP addresses so that the IP address is not assigned to another UE device 110 and thus becomes unavailable if UE device 110 requests to establish another PDU session.

Process 1100 may further include receiving another PDU session establishment request for the UE device (block 1170), include obtaining a static IP service authorization for the UE device from the UDM (block 1180), and identifying and using the stored IP address assigned to the UE device (block 1190). For example, SMF 240 may receive another PDU session establishment request for UE device 110 from AMF 220, obtain another static IP service authorization for UE device 110 from UDM 252, and identify the IP address previously assigned to UE device 110 in IP address DB 745. SMF 240 may assign the identified IP address to UE device 110 and establish another PDU session for UE device 110 using the assigned IP address.

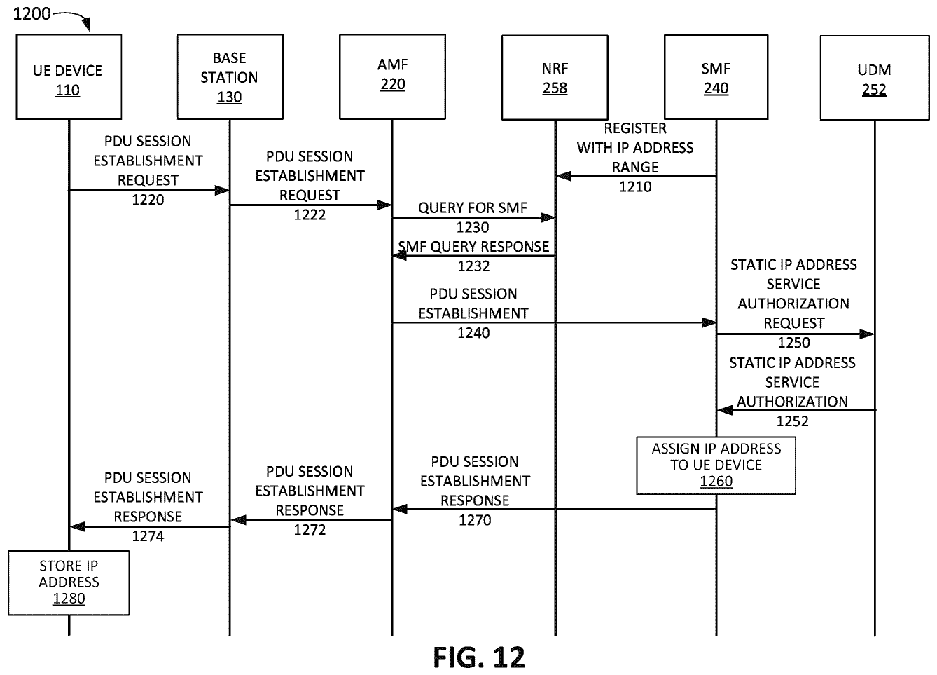

FIG. 12 illustrates a first exemplary signal flow diagram 1200. Signal flow 1200 illustrates an initial assignment of an IP address to UE device 110. As shown in FIG. 12, signal flow 1200 may include SMF 240 registering with NRF 258 with the range of IP addresses associated with SMF 240 (signal 1210). At a later time, UE device 110 may send a PDU session establishment request to AMF 220 via base station 130 (signals 1220 and 1222).

AMF 220 may receive the PDU session establishment request and query NRF 258 for an available SMF 240 (signal 1230). NRF 258 may respond to the request by selecting an available SMF 240 and providing information identifying the selected SMF 240 to AMF 220 (signal 1232). AMF 220 may then send the PDU session establishment request for UE device 110 to SMF 240 (signal 1240).

SMF 240 may send a static IP address service authorization request to UDM 252 (signal 1250) and UDM 252 may respond with the static IP address service authorization (signal 1252). In response, SMF 240 may assign an IP address for UE device 110 and store the association between the IP address and UE device 110, along with the static IP address service authorization, in IP address DB 745 (block 1260). SMF 240 may establish the PDU session by selecting UPF 230 and instructing UPF 230 to set up the PDU session (not shown in FIG. 12). SMF 240 may send a PDU session establishment response to UE device 110 via AMF 220 and base station 130 (signals 1270, 1272, and 1274). The PDU session establishment response may include a flag set to instruct UE device 110 to store the assigned IP address and include the assigned IP address in future PDU session establishment requests. In response, UE device 110 may store the IP address (block 1280).

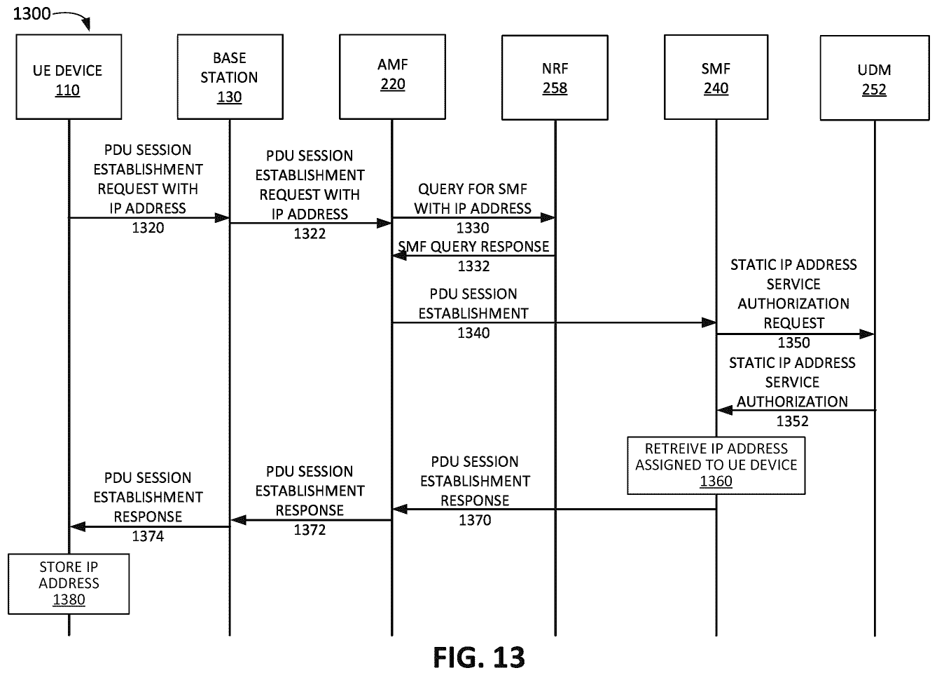

FIG. 13 illustrates a second exemplary signal flow diagram 1300. Signal flow 1300 illustrates a subsequent assignment of an IP address to UE device 110 after the initial assignment of the IP address shown in signal flow 1200. As shown in FIG. 13, signal flow 1300 may include UE device 110 sending a PDU session establishment request to AMF 220 via base station 130 (signals 1320 and 1322). The PDU session establishment request may include the IP address stored by UE device 110.

AMF 220 may receive the PDU session establishment request and query NRF 258 for an SMF 240 associated with the IP address included in the PDU session establishment request by UE device 110 (signal 1330). NRF 258 may respond to the request by selecting SMF 240 associated with the IP address and providing information identifying the selected SMF 240 to AMF 220 (signal 1332). AMF 220 may then send the PDU session establishment request for UE device 110 to the identified SMF 240 (signal 1340).

SMF 240 may send a static IP address service authorization request to UDM 252 (signal 1350) and UDM 252 may respond with the static IP address service authorization (signal 1352). In response, SMF 240 may retrieve the IP address previously assigned to UE device 110 and assign the retrieved IP address to UE device for the PDU session (block 1360). SMF 240 may establish the PDU session by selecting UPF 230 and instructing UPF 230 to set up the PDU session (not shown in FIG. 13). SMF 240 may send a PDU session establishment response to UE device 110 via AMF 220 and base station 130 (signals 1370, 1372, and 1374). The PDU session establishment response may include a flag set to instruct UE device 110 to store the assigned IP address and include the assigned IP address in future PDU session establishment requests. In response, UE device 110 may store the IP address (block 1380).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 8-11, and a series of signals have been described with respect to FIGS. 12 and 13, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a device, a registration request from a Session Management Function (SMF) associated with an Internet Protocol (IP) address range or an IP index;
storing, by the device, information associating the SMF with the IP address range or the IP index;
receiving, by the device and from a network function (NF), a query for a particular SMF associated with an IP address in the IP address range or the IP index;
identifying, by the device, the SMF associated with the IP address or the IP index as the particular SMF; and
providing, by the device and to the NF, information identifying the SMF based on the received query.

2. The method of claim 1, wherein the device includes a Network Repository Function (NRF).

3. The method of claim 2, further comprising:
receiving a network function registration from the SMF, wherein the network function registration request includes information identifying the IP index or the IP address range, wherein the IP address range includes IP addresses used by the SMF for assigning to user equipment (UE) devices when establishing Protocol Data Unit (PDU) sessions.

4. The method of claim 1, wherein the NF corresponds to an Access and Mobility Management Function (AMF), the method further comprising:
receiving, by the AMF and from a user equipment (UE) device, a request to establish a Protocol Data Unit (PDU) session for the UE device, wherein the request includes the IP address or the IP index;
sending, by the AMF, the query to the device;
receiving, by the AMF, the information identifying the SMF; and
sending, by the AMF, a PDU session establishment request to the SMF, in response to receiving the information identifying the SMF.

5. The method of claim 1, further comprising:
receiving, by the SMF, a Protocol Data Unit (PDU) session establishment request for a user equipment (UE) device;
identifying, by the SMF, an IP address previously assigned to the UE device by the SMF;
assigning, by the SMF, the identified IP address to the UE device for the PDU session; and
instructing, by the SMF, the UE device to store the IP address and the IP index and use the stored IP address or IP index when requesting a PDU session.

6. The method of claim 5, further comprising:
sending, by the SMF, a registration request to the device, wherein the device includes a Network Repository Function (NRF), wherein the registration request includes information identifying the IP index or a range of IP addresses used by the SMF for assigning to UE devices when establishing PDU sessions.

7. The method of claim 5, further comprising:
sending, by the SMF and to a Unified Data Management (UDM) function, a request for an authorization for a static IP address service for the UE device;
receiving, by the SMF and from the UDM function, the authorization for the static IP address service for the UE device; and
wherein the assigning the identified IP address to the UE device for the PDU session is based on the received authorization.

8. The method of claim 7, further comprising:
storing, by the UDM function, an indication that the UE device is authorized for the static IP address service;
receiving, by the UDM function and from the SMF, the request for the authorization for the static IP address service for the UE device; and
providing, by the UDM function and to the SMF, the authorization for the static IP address service for the UE device based on the stored indication and the received request.

9. A system comprising:
a device configured to:
receive a registration request from a Session Management Function (SMF) associated with an Internet Protocol (IP) address range or an IP index;
store information associating the SMF with the IP address range or the IP index;
receive, from a network function (NF), a query for a particular SMF associated with an IP address in the IP address range or the IP index;
identify the SMF associated with the IP address or the IP index as the particular SMF; and
provide, to the NF, information identifying the SMF based on the received query.

10. The system of claim 9, wherein the device includes a Network Repository Function (NRF).

11. The system of claim 10, wherein the device is further configured to:
receive a network function registration request from the SMF, wherein the network function registration request includes information identifying the IP index or the IP address range, wherein the IP address range includes IP addresses used by the SMF for assigning to user equipment (UE) devices when establishing Protocol Data Unit (PDU) sessions.

12. The system of claim 9, further comprising:
a second device configured to implement an Access and Mobility Management Function (AMF) corresponding to the NF, wherein the AMF is configured to:
receive, from a user equipment (UE) device, a request to establish a Protocol Data Unit (PDU) session for the UE device, wherein the request includes the IP address or the IP index;
send the query to the device;
receive the information identifying the SMF; and
send a PDU session establishment request to the SMF, in response to receiving the information identifying the SMF.

13. The system of claim 9, further comprising:
a second device configured to implement the SMF, wherein the SMF is configured to:
receive a Protocol Data Unit (PDU) session establishment request for a user equipment (UE) device;
identify an IP address previously assigned to the UE device by the SMF;
assign the identified IP address to the UE device for the PDU session; and
instruct the UE device to store the IP address and the IP index and use the stored IP address or IP index when requesting a PDU session.

14. The system of claim 13, wherein the SMF is further configured to:
send a registration request to the device, wherein the device includes a Network Repository Function (NRF), wherein the registration request includes information identifying the IP index or a range of IP addresses used by the SMF for assigning to UE devices when establishing PDU sessions.

15. The system of claim 13, wherein the SMF is further configured to:
send, to a Unified Data Management (UDM) function, a request for an authorization for a static IP address service for the UE device;
receive, from the UDM function, the authorization for the static IP address service for the UE device; and
wherein the SMF is configured to assign the identified IP address to the UE device for the PDU session is based on the received authorization.

16. The system of claim 15, further comprising:
a third device configured to implement the UDM, wherein the UDM is configured to:
store an indication that the UE device is authorized for the static IP address service;
receive, from the SMF, the request for the authorization for the static IP address service for the UE device; and
provide, to the SMF, the authorization for the static IP address service for the UE device based on the stored indication and the received request.

17. A non-transitory computer-readable memory device storing instructions executable by a processor, the non-transitory computer-readable memory device comprising:
one or more instructions to receive a registration request from a Session Management Function (SMF) associated with an Internet Protocol (IP) address range or an IP index;
one or more instructions to store information associating the SMF with the IP address range or the IP index;
one or more instructions to receive, from a network function (NF), a query for a particular SMF associated with an IP address in the IP address range or the IP index;
one or more instructions to identify the SMF associated with the IP address or the IP index as the particular SMF; and
one or more instructions to provide, to the NF, information identifying the SMF based on the received query.

18. The non-transitory computer-readable memory device of claim 17, wherein the NF corresponds to an Access and Mobility Management Function (AMF), the non-transitory computer-readable memory device further comprising:
one or more instructions to receive, by the AMF and from a user equipment (UE) device, a request to establish a Protocol Data Unit (PDU) session for the UE device, wherein the request includes the IP address or the IP index;
one or more instructions to send, by the AMF, the query to the device;
one or more instructions to receive, by the AMF, the information identifying the SMF; and
one or more instructions to send, by the AMF, a PDU session establishment request to the SMF, in response to receiving the information identifying the SMF.

19. The non-transitory computer-readable memory device of claim 17, further comprising:
one or more instructions to receive, by the SMF, a Protocol Data Unit (PDU) session establishment request for a user equipment (UE) device;
one or more instructions to identify, by the SMF, an IP address previously assigned to the UE device by the SMF;
one or more instructions to assign, by the SMF, the identified IP address to the UE device for the PDU session; and
one or more instructions to instruct, by the SMF, the UE device to store the IP address and the IP index and use the stored IP address or IP index when requesting a PDU session.

20. The non-transitory computer-readable memory device of claim 19, further comprising:
one or more instructions to send, by the SMF and to a Unified Data Management (UDM) function, a request for an authorization for a static IP address service for the UE device;
one or more instructions to receive, by the SMF and from the UDM function, the authorization for the static IP address service for the UE device; and
wherein the assigning the identified IP address to the UE device for the PDU session is based on the received authorization.
